(19) United States
(12) Patent Application Publication
(10) Pub. No.: US 2011/0265497 A1
(43) Pub. Date: Nov. 3, 2011

(54) Microtome Cassette Clamp Having An Air Channel For Dissipating The Heat Of A Cooling Element, And Microtome

(75) Inventors: Karl-Heinz Westerhoff, Eppingen-Elsenz (DE); Claudia Dorenkamp, Muehlhausen (DE); Christian Lorenz, Wiesloch (DE); Eva Goedecke, Plankstadt (DE)

(73) Assignee: LEICA BIOSYSTEMS NUSSLOCH GMBH, Nussloch (DE)

(21) Appl. No.: 13/093,888

(22) Filed: Apr. 26, 2011

(30) Foreign Application Priority Data
Apr. 30, 2010 (DE) 10 2010 016 728.2

(51) Int. Cl. F25D 25/00; F25B 21/02; B26D 7/08; F25D 31/00

(52) U.S. Cl. 62/62; 62/320; 62/3.2

(57) ABSTRACT

A device for cooling a tissue sample on a microtome includes a cooling element (44), a first air channel (32), and a ventilation device (22). The cooling element (44) has a cold region facing the tissue sample and a hot region which faces away from the tissue sample and dissipates the heat generated in the cooling element (44) to the ambient environment. The first air channel (32) is provided for dissipating the heat released by the cooling element (44). The ventilation device (22) generates an air flow through the first air channel (32), said air flow absorbing and removing the heat released via the hot region of the cooling element (44).

### CROSS REFERENCE TO RELATED APPLICATIONS

This application claims priority of German patent application number 10 2010 016 728.2 filed Apr. 30, 2010, the entire disclosure of which is incorporated by reference herein.

### FIELD OF THE INVENTION

The present invention relates to a device and a method for cooling a tissue sample on a microtome. The present invention also relates to a microtome which includes said device for cooling tissue samples so as to provide for cooling of tissue samples to be sectioned.

### BACKGROUND OF THE INVENTION

Before tissue samples can be examined using a microscope, they generally have to be prepared for this purpose. To this end, the tissue samples are embedded in a support medium, such as paraffin. The paraffin blocks containing the embedded tissue samples are held in cassettes, which are storable in suitable cassette magazines. Subsequently, the embedded tissue samples are cut with a microtome into extremely thin sections, which can then be examined by the microscope.

During sectioning, the embedded tissue samples are cooled to keep them in an optimum condition. In order to do this, it is known to provide cooling elements, such as Peltier elements, and to thermally couple said elements to the tissue samples and/or the cassettes containing the tissue samples. In the case of the known cooling devices, the heat of the Peltier element is transferred to the housing of the microtome or of the cooling device. During prolonged operation of the microtome, the material of the cooling device, of the microtome, or of a feed mechanism of the microtome may be heated to such a degree that the tissue samples are no longer sufficiently cooled and/or that the functioning of the feed mechanism is impaired. In addition, the performance of the Peltier element decreases the longer it is continuously used, because the heat generated in the Peltier element is not consistently dissipated.

### SUMMARY OF THE INVENTION

It is, therefore, an object of the present invention to provide a device and a method for cooling tissue samples on a microtome as well as a microtome which will allow tissue samples to be sectioned in an accurate and simple manner using the microtome.

This object is achieved by the features of the invention and the advantageous embodiments described herein. The device includes a cooling element having a cold region facing the tissue sample and a hot region which faces away from the tissue sample and dissipates the heat generated in the cooling element to the ambient environment.

According to a first aspect of the present invention, a first air channel is provided for dissipating the heat released by the cooling element. A ventilation device is provided for generating an air flow in the first air channel. The air flow absorbs and removes the heat released via the hot region of the cooling element.

The interaction of the cooling element, the first air channel, and the ventilation device allows the heat generated during operation of the cooling element and that absorbed by the cooling element to be consistently dissipated in a particularly simple manner. This effectively helps prevent the tissue samples from heating up to unnecessarily high levels, thereby keeping them in an optimum condition, and also effectively assists in ensuring proper functioning of the feed mechanism for advancing the tissue samples. The device including the cooling element, the ventilation device and the air channel may also be referred to as “RM CoolClamp”.

In an advantageous embodiment, at least one second air channel is provided through which passes a part of the air flow that carries away the heat released from the hot region of the cooling element. Preferably, both the first air channel and the second air channel communicate with a first and a second air inlet, respectively, through which fresh air can be drawn in from the environment surrounding the cooling device.

In a further advantageous embodiment, the device at least partially has a surface made of antistatic material. In particular, preferably the air channel or channels at least partially has/have a surface made of electrically conductive material. The antistatic surface may be provided, for example, by embedding conductive materials in the material at least near the surface thereof.

According to a second aspect of the present invention, the tissue samples are cooled on the microtome. The heat generated in the cooling process, especially the heat from the cooling element, is carried away from the cooling element by the air flow and dissipated into the environment surrounding the device.

According to a third aspect of the present invention, a microtome is provided which includes the device for cooling tissue samples to be sectioned.

BRIEF DESCRIPTION OF THE DRAWING VIEWS

Exemplary embodiments of the present invention are described in more detail below with reference to the drawings, in which:

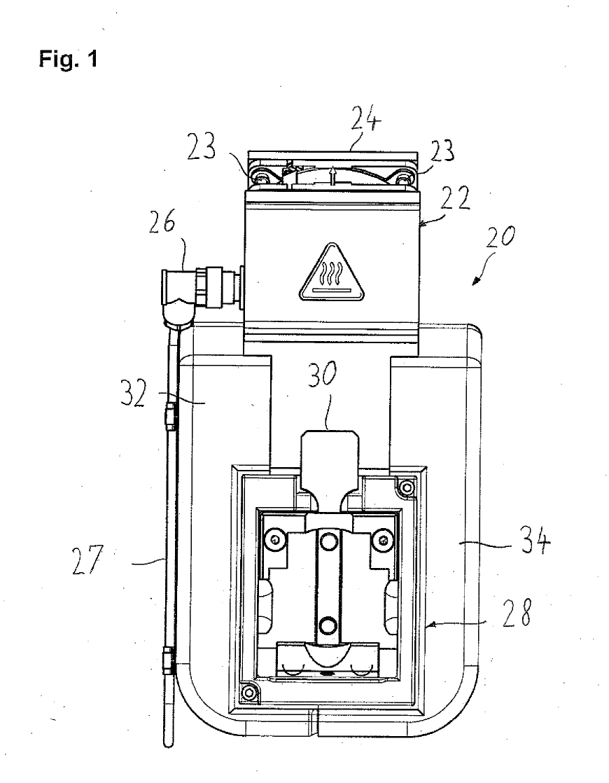

FIG. 1 is a front view of a device for cooling tissue samples;

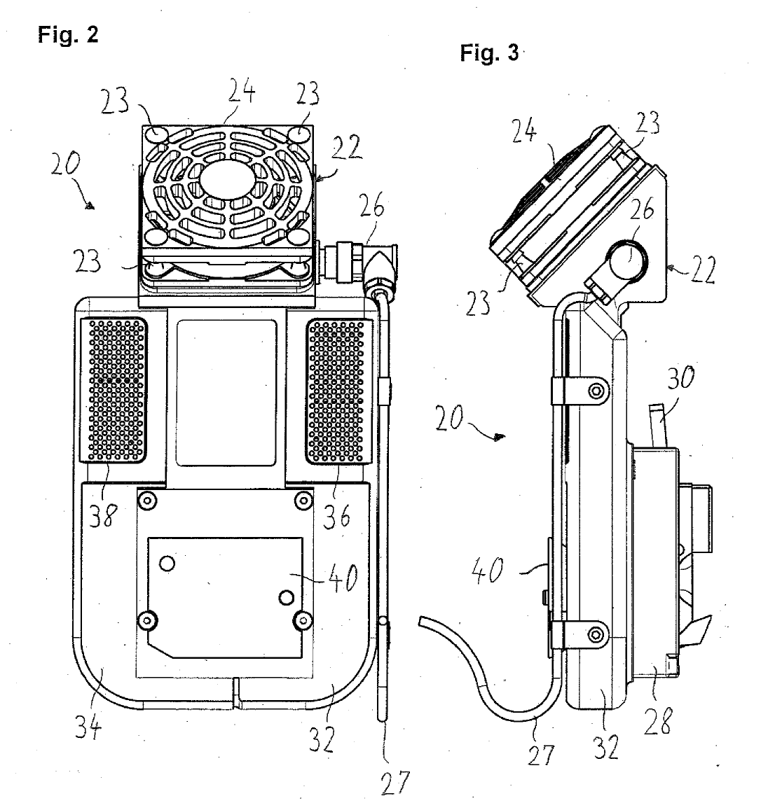

FIG. 2 is a rear view of the device;

FIG. 3 is a side view of the device;

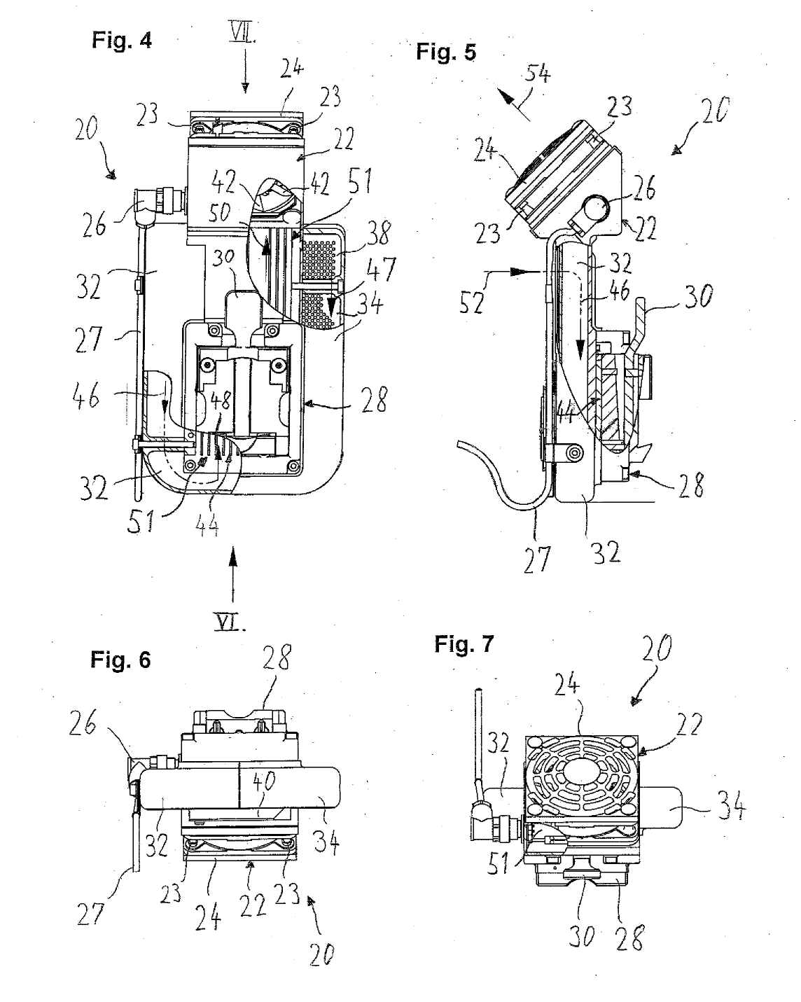

FIG. 4 is a front view of the device with the housing partially in section;

FIG. 5 is a side view of the device with the housing partially in section;

FIG. 6 is a bottom view of the device of FIG. 4; and

FIG. 7 is a top view of the device of FIG. 4 with the housing partially in section.

### DETAILED DESCRIPTION OF THE INVENTION

Elements having the same design or function are identified by the same reference numerals throughout the figures.

FIG. 1 shows a device for cooling tissue samples (not shown). During use, device 20 is attached to a microtome (not shown) for sectioning tissue samples. The tissue samples are embedded in a support medium, such as paraffin. A paraffin block containing tissue samples is held in a cassette. Device 20 serves to receive and hold the cassettes containing the tissue samples during sectioning of the tissue samples and to cool them during the sectioning operation.

Device 20 includes a ventilation device 22. Ventilation device 22 has a cover 24, which is attached by fastening elements 23 to a base plate of ventilation device 22. Ventilation device 22 has a rotor (not shown). The rotor is driven electrically and coupled to a power supply via a connector 26 and a cable 27. In addition, a control line may extend through connector 26 and a cable 27 for purposes of controlling a power of ventilation device 22.

Device 20 further includes a first air channel 32 and a second air channel 34 through which an air flow passes when ventilation device 22 is operating. The two air channels 32, 34 extend parallel to each other, each at a periphery of device 20. Alternatively, only a single air channel 32, or more than two air channels 32, 34, may be provided.

Furthermore, the device includes a clamp unit 28 having a clamping element 30 which allows a cassette containing a tissue sample to be clamped into clamp unit 28. The tissue sample clamped into clamp unit 28 via the cassette, particularly the paraffin block containing the tissue sample, may be cut into extremely thin sections by a cutting blade of the microtome.

FIG. 2 shows the rear of device 20. The rear view shows a first air inlet 36 and a second air inlet 38. Air can be drawn into first air channel 32 via first air inlet 36. Second air inlet 38 allows air to be drawn into second air channel 34. The two air inlets 36, 38 are provided by openings in air channels 32, 34, said openings being covered by mesh screens. The rear view of device 20 further shows a coupling element 40, via which device 20 is attachable to the microtome.

FIG. 3 shows device 20 from the side, revealing that coupling element 40 is a male part of a dovetail connection. A corresponding female part of the dovetail connection is formed on the microtome. Thus, device 20 can be fixed to the microtome via the dovetail connection. Alternatively, the device may be attached to the microtome in a different way.

FIG. 4 is a front view similar to FIG. 1, but showing the housing of device 20 partially in section. In particular, the two air channels 32, 34 are shown in section, thereby partially revealing the volume within the air channels. During operation, ventilation device 22 generates an air flow through each of air channels 32, 34. These air flows respectively pass through first air channel 32 in a first flow direction 46, and through second air channel 34 in a second flow direction 47. First and second flow directions 46, 47 point away from first air inlet 36, second air inlet 38 and ventilation device 22 toward a first end of device 20. At the first end, the two air flows are combined and passed through a common air channel 51 in a third flow direction 48 opposite to first and second flow directions 46, 47, thereby causing the air flow to pass over a cooling element 44, in particular a Peltier element. Common air channel 51 forms a portion of first air channel 32 and a portion of section air channel 34.

Cooling element 44 is controlled via cable 27 and includes a cold region and a hot region, neither of which are shown herein. The cold region is directed toward clamp unit 28 and thus faces the tissue sample during operation of the microtome, so that the tissue sample can be cooled by cooling element 44 during the sectioning operation. The hot region faces away from clamp unit 28 and dissipates the heat generated in cooling element 44 and that absorbed by cooling element 44 into the environment surrounding cooling element 44. The air flows in flow direction 48 over the hot region of cooling elements 44, absorbing and removing the released heat. The warm air flow is directed through common air channel 51 in a fourth flow direction 50 toward ventilation device 22.

FIG. 4 further shows two rotor blades 42 of the rotor of ventilation device 22. During operation of ventilation device 22, rotor blades 42 rotate at high speed, generating the air flow through air channels 32, 34.

FIG. 5 shows device 22 from the side with the housing partially in section. This side view shows the air flow that passes through first air channel 32 in first flow direction 46. The air required for this air flow is drawn in through first air inlet 36 in a fifth flow direction 52. The warm exhaust air exits ventilation device 22 in a sixth flow direction 54.

FIGS. 6 and 7 show device 20 of FIG. 4 as seen from above and from below respectively.

Device 20 at least partially has a surface containing an antistatic material. The parts of device 20 which are formed of the antistatic material are in particular those that may come into contact with the sections and sectioning wastes of the microtome. It is possible to provide only the surface or the entire material of corresponding component with antistatic properties. This helps prevent sectioning wastes and sections of tissue samples from adhering to device 20. The antistatic material may be provided, for example, in the form of an antistatic coating. Alternatively, conductive materials may be embedded throughout the material or only at its surface, said conductive materials preventing the surface from being statically charged. For example, it is possible for the respective housing parts to contain an electrically conductive plastic. The electrical conductivity may be achieved, for example, by embedding metallic conductors into the plastic. In particular, it is possible to embed a metal mat, a steel fiber braid, a metal mesh, metal fibers, and/or a metal layer into the plastic. In addition, the conductive regions may be conductively interconnected and/or grounded.

The present invention is not limited to the exemplary embodiments described herein. For example, it is possible to provide a greater or smaller number of air channels 32, 34 and/or ventilation devices 22. Moreover, air channels 32, 34 may be routed differently as long as it is ensured that the air flow through air channels 32, 34 absorbs the heat of cooling element 44.

### LIST OF REFERENCE NUMERALS

20 device for cooling tissue samples

22 ventilation device

23 fastening element

24 cover

26 connector

27 cable

28 clamp unit

30 clamping element

32 first air channel

34 second air channel

36 first air inlet

38 second air inlet

40 coupling element

42 rotor blade

44 cooling element

46 first flow direction

47 second flow direction

48 third flow direction

50 fourth flow direction

51 common air channel

52 fifth flow direction

54 sixth flow direction

What is claimed is:

1. A device for cooling a tissue sample on a microtome, the device comprising:
a cooling element having a cold region which faces the tissue sample, and a hot region which faces away from the tissue sample and releases heat generated in the cooling element to an ambient environment; and
at least one air channel for dissipating heat released from the cooling element and a ventilation device which generates an air flow through the at least one air channel;
the at least one air channel being configured and arranged such that the air flow through the at least one air channel passes over the hot region of the cooling element to absorbing and remove heat released from the hot region of the cooling element.

2. The device as recited in claim 1, further comprising at least one air inlet communicating with the at least one air channel and through which air enters the at least one air channel.

3. The device as recited in claim 2, wherein the at least one air channel includes a first air channel and a second air channel, and the at least one air inlet includes a first air inlet through which air enters the first air channel and a second air inlet through which air enters the second air channel.

4. The device as recited in claim 1, wherein the cooling element includes a Peltier element.

5. The device as recited in claim 1, wherein the device includes a surface made of antistatic material.

6. The device as recited in claim 5, wherein the surface made of antistatic material is a surface of the at least one air channel.

7. The device as recited in claim 1, further comprising a clamp unit for fixing a cassette containing a tissue sample in position, wherein the clamp unit is disposed such that the cold region of the cooling element faces the clamp unit.

8. The device as recited in claim 1, further comprising a coupling element for fixing the device to the microtome, wherein the coupling element is disposed such that the hot region of the cooling element faces the coupling element.

9. A microtome comprising a device for cooling a tissue sample on the microtome, wherein the device includes:
a cooling element having a cold region which faces the tissue sample, and a hot region which faces away from the tissue sample and releases heat generated in the cooling element to an ambient environment; and
at least one air channel for dissipating heat released from the cooling element and a ventilation device which generates an air flow through the at least one air channel;
the at least one air channel being configured and arranged such that the air flow through the at least one air channel passes over the hot region of the cooling element to absorbing and remove heat released from the hot region of the cooling element.

10. A method for cooling a tissue sample on a microtome, the method comprising the steps of:
providing a cooling element having a cold region facing the tissue sample on the microtome and a hot region facing away from the tissue sample; and
generating an air flow by operating a ventilation device, the air flow being directed through an air channel so that the air flow passes over the hot region of the cooling element to absorb and remove heat released from the hot region of the cooling element.
